(19) United States
(12) Patent Application Publication
(10) Pub. No.: US 2002/0079061 A1
(43) Pub. Date: Jun. 27, 2002

(54) Masking machine

(76) Inventor: Stuart Arnott, Winnipeg (CA)

Correspondence Address: AIKINS, MACAULAY & THORVALDSON, 30TH FLOOR COMMODITY EXCHANGE TOWER, 360 MAIN STREET, WINNIPEG, MB, R3C 4G1, CA

(21) Appl. No.: 10/025,747

(22) Filed: Dec. 26, 2001

(30) Foreign Application Priority Data
Dec. 27, 2000 (CA) 2,329,631

(51) Int. Cl. B44C 7/00; B44C 7/04

(52) U.S. Cl. 156/577; 156/574

(57) ABSTRACT

A masking machine for plural rolls of masking paper has a generally triangular shape with triangular front and back frames joined by a base and a number of cross members. The cross members support inclined roll supports at both ends. The base of the machine is mounted on castor wheels for portability. Paper and masking tape applied to an edge of the paper are guided out of the machine by horizontal guide rods and outer cutter bars which are conveniently positioned across the front of the frame.

### FIELD OF THE INVENTION

The present invention relates to an apparatus of the type known as a masking machine for use in dispensing strips of masking material.

### BACKGROUND

In painting objects, for example automobiles or houses, it is often necessary to mask areas of the object which are not to be painted. A masking machine is often used in this process for connecting a strip of masking tape to the edge of a length of masking paper as the paper is withdrawn from a roll.

The existing masking machines often have a limited capacity for roll materials of different sizes and generally will not carry all of the materials needed in a particular masking operation. Because of their designs, the prior art machines often suffer from mechanical failures. These known machines may be difficult to move around a shop, and with many masking machines, tools, e.g. wrenches, are required to change the rolls of paper.

The present invention addresses concerns with the prior art and proposes a novel masking machine design.

### SUMMARY

According to the present invention there is provided a masking machine for plural rolls of masking sheet material, said machine comprising:

a frame including:

spaced apart front and back sides, each with a base member and two end members converging upwardly from the base member to define upwardly convergent ends of the frame;

cross members extending across the ends of the frame and joining the end members of the front and back sides; and

a plurality of roll support members positioned between the front and back sides and extending between the ends of the frame, the roll support members being vertically spaced apart and supported at opposite ends by the cross members.

The upwardly convergent design accommodates the various paper roll sizes in a stable design that minimizes space requirements. The dimension between the front and back sides of the frame need only be sufficient to accommodate the paper rolls and any necessary guides for the paper.

In preferred embodiments, the roll supports are inclined downwardly and towards one end, so that the roll is held in place by gravity. The end of the roll may be supported by a spring pin that may in turn be selectively positioned along the support to accommodate paper rolls of differing lengths.

To enable quick and tool-free exchange of rolls, the roll support is preferably removably supported on the cross members.

Each roll support is preferably associated with a respective cut-off member extending across the front side of the frame in front of the roll support. The cut-off members are preferably arranged horizontally, parallel to the base members or the front and back sides.

To guide the paper off the rolls, guide rods may be mounted on the frame in front of the rolls. Where cut-off members are used, the rods are positioned between the rolls and the cut-off members, parallel to the cut-off members.

To apply masking tape to one edge of the paper as it is drawn from the rolls, the machine may include vertically spaced apart tape holders mounted at one end of the frame between the rolls and the back of the frame. This applies the tape over a large portion of the circumference of the roll to ensure a good, smooth adhesion of the tape to the paper roll.

The preferred frame has front and back sides of a generally triangular shape, preferably isosceles. This accommodates the larger rolls at the bottom and smaller rolls towards the top. The shape itself is more robust than configurations known in the prior art.

By using four caster wheels for support of the base, the unit may be moved easily about a shop, while being very stable in use. This also allows the unit to be made from robust, damage resistant materials of greater weight than prior art two-wheel devices, which must be sufficiently light that they may be tipped up to one side for movement.

### BRIEF DESCRIPTION OF THE DRAWINGS

In the accompanying drawings, which illustrate an exemplary embodiment of the present invention:

FIG. 1 is an isometric view of a masking machine according to the present invention from the front and right;

FIG. 2 is an isometric view of a masking machine according to the present invention from the left and back;

FIG. 3 is a right end view of the masking machine;

FIG. 4 is a left end view of the masking machine;

FIG. 5 is a partial sectional view showing the application of masking tape to a roll of paper; and

FIG. 6 is a cross section along line 6-6 of FIG. 1.

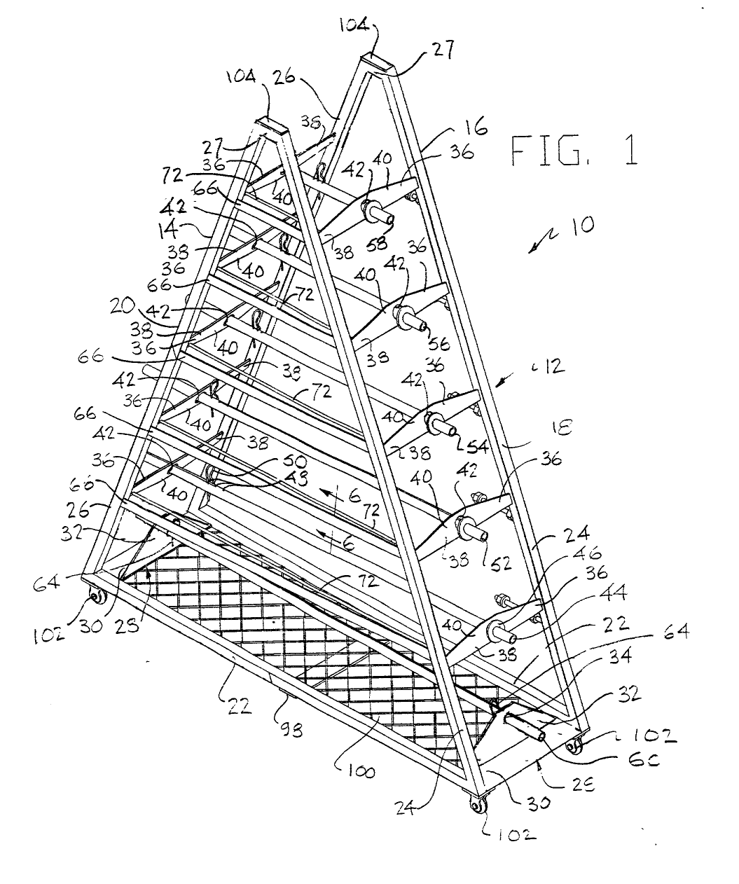

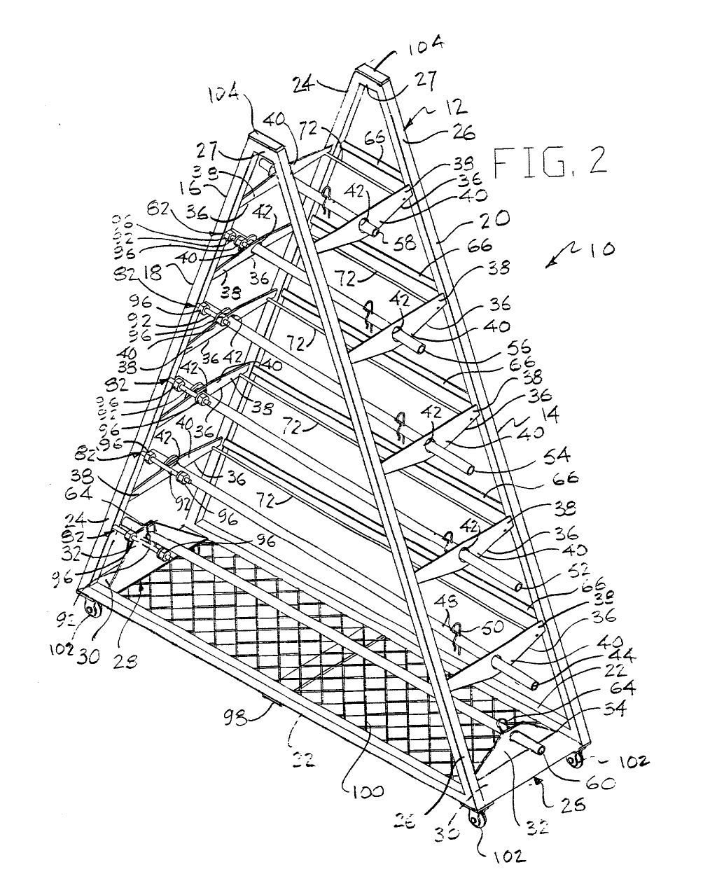

### DETAILED DESCRIPTION

Referring to the accompanying drawings, there is illustrated a masking machine 10 that includes a frame 12. The frame is a space frame with triangular front and back sides 14 and 16 respectively, a right end 18 and a left end 20. Each side of the frame includes a horizontal base member 22, a right end member 24 and a left end member 26. The right and left end members converge from the ends of the base member towards the top where they are joined by a short cap 27.

The two triangular sides are joined at the opposite ends of their bases by base cross members 28. Each cross member includes a rectangular flange 30 that extends across the bottom of the two base members 22 and is secured to them adjacent their ends. The cross member also includes an upright trapezoidal flange 32 with an aperture 34 adjacent its upper end.

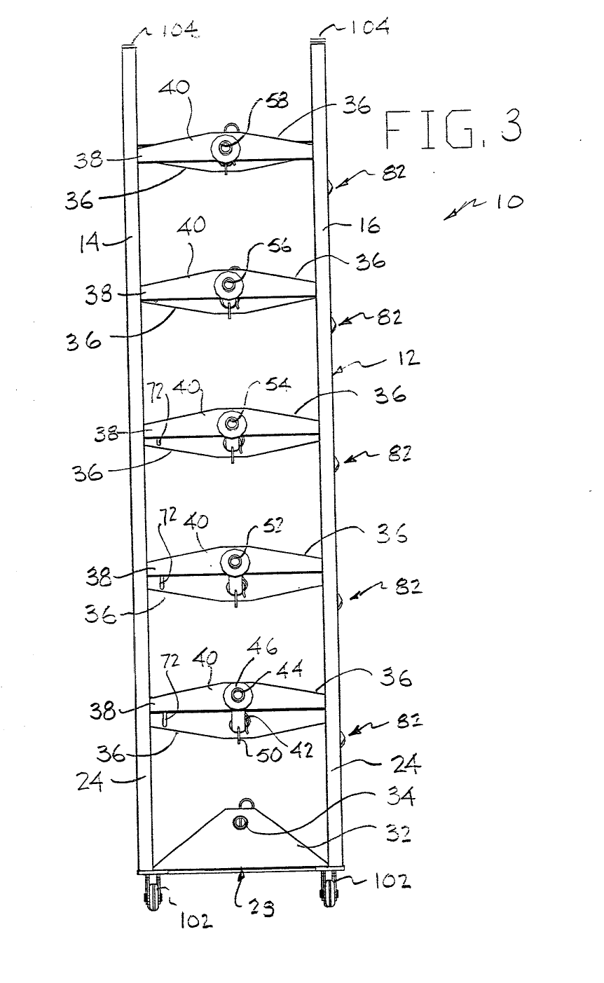

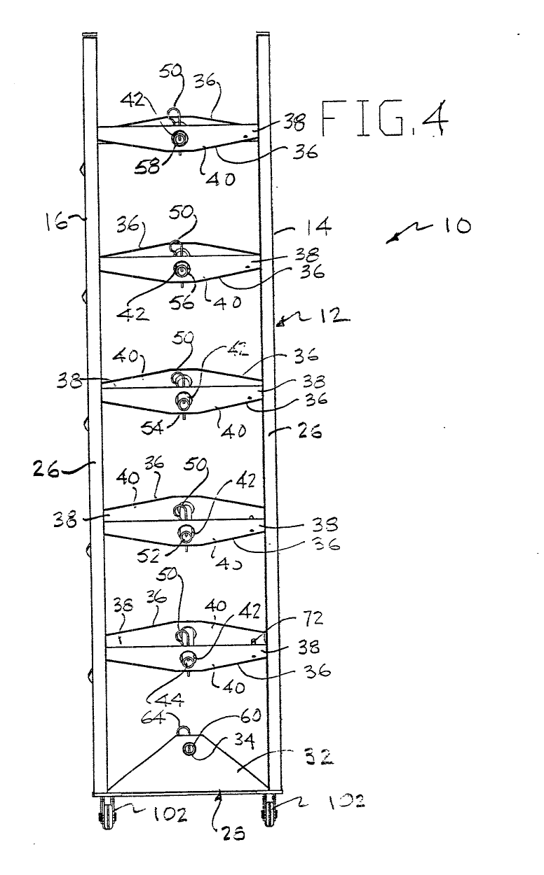

The front and back sides of the frame are also joined by two sets of five cross members 36, one set at the right end and the other at the left end. Each cross member is a plate with a rectangular section 38 and a trapezoidal section 40 with an aperture 42 formed between the two sections. As shown most particularly in FIGS. 3 and 4, the cross members at the right end of the frame are mounted with the trapezoidal sections at the top while the cross members at the left end are inverted, with the trapezoidal sections at the bottom. In addition, the cross members at the left and right are aligned with the base of the rectangular section of one being aligned vertically with the base of the rectangular section of the other. This means that a line through the apertures 42 of two corresponding cross members will slope down from the right to the left.

The bottom-most cross members 36 at the left and right ends support a roll support tube 44 which engages in the apertures 42 of the two cross members. The tube carries an inclined flange 46 adjacent one end to support the tube on the right end cross member 36.

Spaced from the opposite end of the tube are a series of apertures 48 that are selectively engaged by spring pins 50 to support the lower or left end of a paper roll.

Four additional support tubes 52, 54, 56 and 58 are mounted in the other pairs of cross members 36. They are configured in the same way but are shorter to accommodate the narrowing width of the frame towards the top and paper rolls of shorter length.

At the bottom of the frame a horizontal support tube 60 extends through the apertures 34 of the base cross members. This is horizontal and not inclined. This material is also used in masking in an automotive environment. The plastic roll support tube has two apertures positioned adjacent its opposite ends to receive respective spring pins 64.

Across the front side of the frame 14 are five cutter bars 66 that are oriented horizontally and positioned in front of the roll support tubes 44, 52, 54, 56 and 58 respectively. Each cutter bar has a bevel 68 along the bottom to provide a cutting edge 70. Positioned between each cutter bar 66 and the respective roll support tube is a guide rod 72. The guide rod is horizontal and secured to the cross members 36.

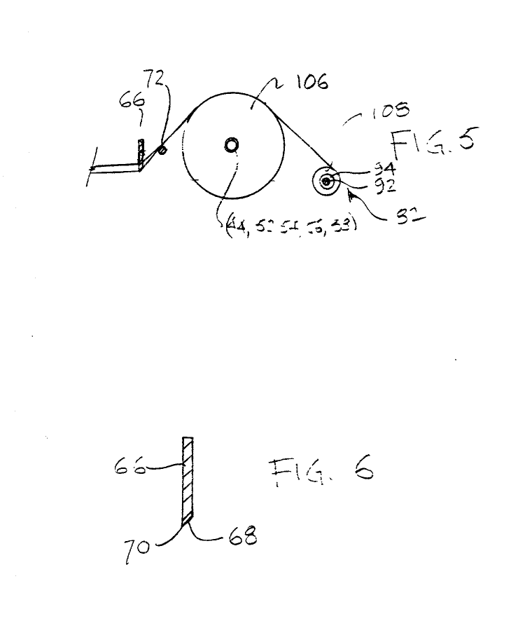

To apply masking tape to the edge of a strip of paper as it is pulled from a roll, five tape holders 82 are mounted on the back side of the frame. These project inwardly from the right end, parallel to the plural support tubes. They are positioned below the cross members 36. Each tape holder includes a threaded rod 92 secured to the right end member 24 of the frame and a disk-like core 94 (FIG. 5) mounted on the threaded rod by two lock nuts 96 that provide for adjustment of the core along the threaded rod.

The base of the frame is completed with a center cross member 98 extending from the front side to the back to join the base members 22 at the center and an expanded metal mesh panel 100 that can be used for supporting any auxiliary tools that may be required while allowing dust to fall through to the floor.

At the corners of the base, are castor wheels 102. These allow the masking machine to be moved readily to any desired location in a shop.

At the top of the frame, a cork pad 104 is glued to the cap 47 to provide a safe place to hold razor blades that are used in masking.

As illustrated schematically in FIG. 5, five paper rolls 106 (one shown) of differing lengths are mounted on the five roll support tubes 44, 52, 54, 56 and 58. A roll of plastic sheeting (not shown) is mounted on the plastic roll support tube 60. Five rolls of masking tape 108 (one shown, FIG. 5) are mounted on the discs 94 of the tape holders 82 with the masking tape being pulled off the roll of masking tape and onto the edge of a respective sheet of paper as it is pulled off its roll.

Paper is easily installed on this machine simply by pulling the spring pin 50 from the associated roll support tube and pulling the roll support tube out of the machine far enough to release the core of a roll being replaced and to install a new roll on the tube. When the new roll is in place, the spring pin can be reinstalled to hold the roll in the correct position. Gravity holds the rolls in the correct position.

While one embodiment of the present invention has been described in the foregoing, it is to be understood that other embodiments are possible within the scope of the invention as will be apparent to those knowledgeable in the art. The invention is therefore to be considered limited solely by the scope of the appended claims.

1. A masking machine for plural rolls of masking sheet material, said machine comprising:
a frame including:
spaced apart front and back sides, each with a base member and two end members converging upwardly from the base member to define upwardly convergent ends of the frame;
cross members extending across the ends of the frame and joining the end members of the front and back sides; and
a plurality of roll support members positioned between the front and back sides and extending between the ends of the frame, the roll support members being vertically spaced apart and supported at opposite ends by the cross members.

2. A machine according to claim 1 wherein the roll support members are inclined with respect to the base members and slope from one of the ends of the frame towards the other of the ends of the frame.

3. A machine according to claim 1 wherein each roll support member is removably supported on the associated cross members.

4. A machine according to claim 1 including a plurality of vertically spaced apart cut-off members extending across the front side of the frame in front of respective ones of the roll supports.

5. A machine according to claim 4 wherein the cut-off members are substantially parallel to the base members.

6. A machine according to claim 4 including a plurality of vertically spaced apart guide rods extending across the front of the respective roll support members.

7. A machine according to claim 4 including a plurality of vertically spaced apart guide rods extending across the frame between the respective roll support members and the cut-off members.

8. A machine according to claim 6 wherein the cut-off members and the guide rods are substantially parallel to the base members.

9. A machine according to claim 1 including a plurality of vertically spaced apart tape holders mounted on the frame between the back side of the frame and the respective roll supports.

10. A machine according to claim 1 wherein the base member and the end members of each side of the frame comprise a substantially isosceles triangle.
